(19) United States
(12) Patent Application Publication
(10) Pub. No.: US 2010/0046963 A1
(43) Pub. Date: Feb. 25, 2010

(54) OPTICAL REGENERATING APPARATUS AND OPTICAL REGENERATING METHOD

(75) Inventors: Masaru Akizawa, Kawasaki (JP); Hisaya Sakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/568,132

(22) Filed: Sep. 28, 2009

Related U.S. Application Data
(63) Continuation of application No. PCT/JP2007/057226, filed on Mar. 30, 2007.

(51) Int. Cl. H04B 10/04

(52) U.S. Cl. 398/197

(57) ABSTRACT

An optical regenerating apparatus includes a photoreceiver unit that receives an optical signal and converts the optical signal into an electrical signal; a reproducing unit that identifies a code of the electrical signal by comparing the electrical signal with a threshold, and reproduces and outputs the identified code; a threshold adjusting unit that calculates a threshold that is lower than the central value of the amplitude of the electrical signal and according to the calculated threshold, adjusts the threshold at the reproducing unit; and a control unit that, based on a variation in the power of the electrical signal, controls the adjustment of the threshold by the threshold adjusting unit.

### FIELD

The embodiments discussed herein are related to an optical regenerating apparatus and an optical regenerating method.

### BACKGROUND

Optical communication systems employing a wavelength division multiplexing (WDM) scheme of multiplexing optical signals of different wavelengths have been conventionally used. In WDM optical communication systems, it is common to increase or decrease wavelengths (CHs: channels) according to the amount of utilization of a line to reduce costs.

FIG. 15 is a block diagram of a WDM optical communication system. As depicted in FIG. 15, a WDM optical communication system 1500 includes an optical transmitting apparatus 1510, a transmission path 1520, and an optical receiving apparatus 1530. The optical transmitting apparatus 1510 includes transmitting devices 1511a to 1511e (Tx) and a multiplexing unit 1512.

The transmitting devices 1511a to 1511e respectively generate an optical signal of a different wavelength and output the respective optical signals to the multiplexing unit 1512. The multiplexing unit 1512 multiplexes the optical signals output from the transmitting devices 1511a to 1511e and transmits the multiplexed WDM optical signal to the optical receiving apparatus 1530 through the transmission path 1520.

The transmission path 1520 includes optical amplifiers 1521 that amplify the WDM optical signal. The optical receiving apparatus 1530 includes a demultiplexing unit 1531 and receiving devices 1532a to 1532e (Rx). The demultiplexing unit 1531 demultiplexes the WDM optical signal transmitted from the optical transmitting apparatus 1510.

The demultiplexing unit 1531 outputs the demultiplexed optical signals to the receiving devices 1532a to 1532e according to wavelength. Each of the receiving devices 1532a to 1532e supports a different wavelength and receives an optical signal output from the demultiplexing unit 1531. Here, the transmitting device 1511a and the receiving device 1532a form an operating CH and an example where the transmitting devices 1511b to 1511e are additionally provided as additional CHs will be described.

FIG. 16 is a waveform diagram of an example of variation of an optical signal in the optical receiving apparatus when the transmitting devices are additionally provided. In FIG. 16, a reference numeral “1610” denotes an optical signal for an operating CH in the optical receiving apparatus 1530. When the transmitting devices 1511b to 1511e are additionally provided, the power of the optical signal 1610 suddenly varies due to the influence of the optical amplifier 1521 in the transmission path 1520.

In this example, the power of the optical signal 1610 suddenly decreases during a time period 1621, and the power of the optical signal 1610 increases during a time period 1622. After the time period 1622, the power of the optical signal 1610 returns the original magnitude of power. The length of each of the time periods 1621 and 1622 is, for example, several hundred ms.

When the optical signal 1610 is intensity-modulated, interpretation of the optical signal 1610 becomes difficult or impossible during the time period 1621 in which the power of the optical signal 1610 decreases and therefore, errors at the optical receiving apparatus 1530 increase. Hence, when CHs are additionally provided, it is demanded that no errors occur in the CHs that are in operation.

An optical signal amplified by the optical amplifier 1521 in the transmission path 1520 includes noise caused by amplified spontaneous emission (ASE). The noise caused by the ASE, in turn, causes errors at the optical receiving apparatus 1530. Accordingly, a conventional optical regenerating apparatus reduces errors by adjusting the threshold used to interpret the amplified optical signal 1610 such that the threshold becomes lower than the central value of the amplitude of the optical signal 1610.

FIG. 17 is a block diagram of a conventional optical regenerating apparatus. As depicted in FIG. 17, a conventional optical regenerating apparatus 1700 includes a photoreceiver element 1710, a pre-amplifier 1720, a reproducing unit 1730, a capacitor 1740, a low pass filter 1750 (LPF), an analog/digital (A/D) converting unit 1760, a calculating unit 1770, and a digital/analog (D/A) converting unit 1780.

It is assumed that the optical regenerating apparatus 1700 is applied to the receiving device 1532a of the optical receiving apparatus 1530. An optical signal received by the receiving device 1532a of the optical receiving apparatus 1530 is input to the photoreceiver element 1710. The photoreceiver element 1710 receives the input optical signal, converts the optical signal into an electrical signal, and outputs the electrical signal to the pre-amplifier 1720 and the low pass filter 1750. The pre-amplifier 1720 converts the current of the electrical signal output from the photoreceiver element 1710 to voltage and outputs the voltage to the reproducing unit 1730.

The capacitor 1740 is provided between the pre-amplifier 1720 and the reproducing unit 1730. The reproducing unit 1730 interprets the electrical signal (identifies the code thereof as “0” or “1”) by comparing the electrical signal output from the pre-amplifier 1720 with a predetermined threshold. The reproducing unit 1730 then reproduces and outputs the identified code. The reproducing unit 1730 identifies the code of the electrical signal using a threshold adjusted according to a threshold adjustment signal output from the D/A converting unit 1780.

The low pass filter (LPF) 1750 extracts the signal power component of the electrical signal output from the photoreceiver element 1710. The low pass filter 1750 outputs the extracted signal power component to the A/D converting unit 1760. The A/D converting unit 1760 converts the signal power component output from the low pass filter 1750 into a digital signal and outputs the digital signal to the calculating unit 1770.

The calculating unit 1770 calculates a threshold according to the signal power component output from the A/D converting unit 1760. For example, the calculating unit 1770 calculates, as the threshold, a value that is about 30% of the peak-to-peak amplitude (hereinafter, “amplitude”) of the electrical signal output to the reproducing unit 1730. The calculation unit 1770 outputs to the D/A converting unit 1780, a threshold adjustment signal indicating that the threshold is to be adjusted to the calculated threshold.

The calculating unit 1770 is configured by a central processing unit (CPU). The calculating unit 1770 calculates thresholds at predetermined control intervals at the timing at which the CPU configuring the calculating unit 1770 processes. The D/A converting unit 1780 converts the threshold adjustment signal output from the calculating unit 1770 into an analog signal, and outputs the analog signal to the reproducing unit 1730.

FIG. 18 is a diagram of waveforms of signals in components of the optical regenerating apparatus. In FIG. 18, a reference numeral “1810” denotes the electrical signal output from the pre-amplifier 1720, and a reference numeral “1820” denotes a time period (see, e.g., the reference numeral “1621” of FIG. 16) during which the power of the optical signal 1610 received by the receiving device 1532a suddenly decreases due to the addition of the transmitting devices 1511b to 1511e.

During the time period 1820, the power of the electrical signal 1810 also decreases in response to the decrease of the power of the optical signal 1610. A reference numeral “1830” denotes an electrical signal that is output from the pre-amplifier 1720 and that is capacitive-coupled by the capacitor 1740. The central value of the voltage of the electrical signal 1830 becomes zero V due to the capacitive-coupling and therefore, the decrease of the power appears in both the positive direction and the negative direction.

FIG. 19 is a diagram of the adjustment of the threshold in the reproducing unit. In FIG. 19, a reference numeral “1911” denotes the decrease of the power of the electrical signal 1830 (when the decrease of the power is slight), and a reference numeral “1912” denotes the decrease of the power of the electrical signal 1830 (when the decrease of the power is significant).

A reference numeral “1920” denotes a threshold that is 50% of the amplitude of the electrical signal 1830. The calculating unit 1770 calculates a threshold 1930 that is about 30% of the amplitude of the electrical signal 1830. In this case, the reproducing unit 1730 identifies the code of the electrical signal 1830 using the threshold 1930 obtained by offsetting the threshold 1920 (see, e.g., Japanese Laid-Open Patent Publication No. 2003-134088).

However, in the optical regenerating apparatus 1700 that is adapted to adjust the threshold such that the threshold is lower than the central value of the amplitude of the optical signal 1610, when the power of the optical signal 1610 suddenly varies, the process of calculating the threshold 1930 may be unable to keep up with the variation. In this case, identification of the code of the optical signal 1610 is impossible and therefore, a problem arises in that the signal is interrupted.

For example, in a state when the calculation process of the threshold 1930 is unable to keep up with the variation in the power, even if the power of the optical signal 1610 decreases suddenly, the power of the optical signal 1610 is always higher than the threshold 1930 (see the reference numeral “1912” of FIG. 19) and each of the codes of the electrical signal are identified to be “1”. Therefore, identification of the actual codes of the electrical signal 1830 is impossible and the signal is interrupted.

To cope with an interruption of the signal, a backup line is prepared and the line for the operating CHs is switched to the backup line when a signal is interrupted in one of the operating CHs. The backup line is a line other than the line of the transmission path 1520 used by the operating CHs. Hence, further cost for installing the backup line is incurred, arising in a problem of increased cost of the WDM optical communication system 1500.

On the contrary, a configuration may be considered that, by shortening each of the control intervals for the calculation of the threshold 1930 by the calculating unit 1770, enables the calculation process of the threshold 1930 to keep up with variations in the power, even when the power of the optical signal 1610 suddenly varies. However, the CPU configuring the calculating unit 1770 is used for not only the calculation of the threshold 1930 but also for other various processes of the optical regenerating apparatus 1700 and the optical receiving apparatus 1530.

FIG. 20 is a block diagram of an exemplary configuration of an optical communicating apparatus that includes a CPU. As depicted in FIG. 20, the optical communicating apparatus 2000 includes a CPU 2010, a transmitting unit 2020 (Tx), and a receiving unit 2030 (Rx). For example, the optical receiving apparatus 1530 is applicable in the receiving unit 2030.

The CPU 2010 executes a process of monitoring the transmitting unit 2020 and the receiving unit 2030, a process of controlling a laser diode (LD) and an integrated circuit (IC) included in the transmitting unit 2020, a receiving process of the receiving unit 2030, a process of transmitting an alarm signal (ALM) to the optical communication system when an abnormality is detected, etc.

Therefore, when each of the control intervals for the calculation of the threshold 1930 by the calculating unit 1770 is shortened, the processing capacity of the CPU is used for the calculating unit 1770 and therefore, a problem arises in that the processing executed by the CPU for the other components in the optical communicating apparatus are affected. When a CPU is additionally equipped to improve the processing speed of the calculation of the threshold 1930 by the calculating unit 1770, problems such increased cost and increased size of the apparatus further arise.

### SUMMARY

According to an aspect of an embodiment, an optical regenerating apparatus includes a photoreceiver unit that receives an optical signal and converts the optical signal into an electrical signal; a reproducing unit that identifies a code of the electrical signal by comparing the electrical signal with a threshold, and reproduces and outputs the identified code; a threshold adjusting unit that calculates a threshold that is lower than the central value of the amplitude of the electrical signal and according to the calculated threshold, adjusts the threshold at the reproducing unit; and a control unit that, based on a variation in the power of the electrical signal, controls the adjustment of the threshold by the threshold adjusting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an example of a configuration of an optical regenerating apparatus according to a first embodiment;

FIG. 2 is a diagram of threshold adjustment at the reproducing unit;

FIG. 3 is a flowchart of an example of the operation of the optical regenerating apparatus according to the first embodiment;

FIG. 4 is a diagram of a mechanism of the optical regenerating apparatus according to the first embodiment;

FIG. 5 is a block diagram of an exemplary configuration of an optical variation detecting unit of the optical regenerating apparatus according to the first embodiment;

FIG. 6 is a diagram of an example of the operation of the optical variation detecting unit;

FIG. 7 is a diagram of an example of signals in components of the optical regenerating apparatus according to the first embodiment;

FIG. 8 is a block diagram of a first exemplary configuration of an optical variation detecting unit of an optical regenerating apparatus according to a second embodiment;

FIG. 9 is a diagram of an example of the operation of the optical variation detecting unit included in the optical regenerating apparatus according to the second embodiment;

FIG. 10 is a block diagram of a second exemplary configuration of the optical variation detecting unit of the optical regenerating apparatus according to the second embodiment;

FIG. 11 is a diagram of an example of signals in components of the optical regenerating apparatus according to the second embodiment;

FIG. 12 is a block diagram of an example of a configuration of an optical regenerating apparatus according to a third embodiment;

FIG. 13 is a block diagram of an example of a configuration of an optical regenerating apparatus according to a fourth embodiment;

FIG. 14 is a diagram of an example of signals in components of the optical regenerating apparatus according to the fourth embodiment;

FIG. 15 is a block diagram of a WDM optical communication system;

FIG. 16 is a waveform diagram of an example of variation of an optical signal in the optical receiving apparatus when the transmitting devices are additionally provided;

FIG. 17 is a block diagram of a conventional optical regenerating apparatus;

FIG. 18 is a diagram of waveforms of signals in components of the optical regenerating apparatus;

FIG. 19 is a diagram of the adjustment of the threshold in the reproducing unit; and

FIG. 20 is a block diagram of an exemplary configuration of an optical communicating apparatus that includes a CPU.

### DESCRIPTION OF EMBODIMENTS

Preferred embodiments of the present invention will be explained with reference to the accompanying drawings.

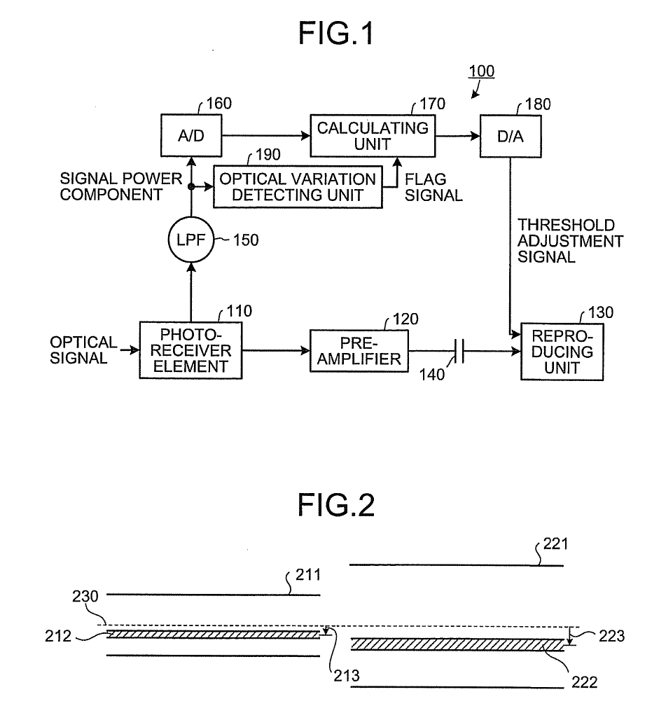

FIG. 1 is a block diagram of an example of a configuration of an optical regenerating apparatus according to a first embodiment. As depicted in FIG. 1, the optical regenerating apparatus 100 according to the first embodiment includes a photoreceiver element 110, a pre-amplifier 120, a reproducing unit 130, a capacitor 140, a low pass filter 150 (LPF), an A/D converting unit 160, a calculating unit 170, a D/A converting unit 180, and an optical variation detecting unit 190.

The photoreceiver element 110 receives an optical signal from another optical communicating apparatus. The photoreceiver element 110 receives the optical signal and converts the optical signal into an electrical signal. The photoreceiver element 110 outputs the electrical signal to the pre-amplifier 120 and the low pass filter 150. The photoreceiver element 110 is, for example, a photo diode. The pre-amplifier 120 converts the current of the electrical signal output from the photoreceiver element 110 to voltage.

The pre-amplifier 120 outputs the electrical signal to the reproducing unit 130. The pre-amplifier 120 is, for example, a current-voltage-converting amplifier (transimpedance amplifier). The capacitor 140 is provided between the pre-amplifier 120 and the reproducing unit 130. The electrical signal output from the pre-amplifier 120 to the reproducing unit 130 is capacitive-coupled by the capacitor 140 and is biased using the central value of the electrical signal.

The reproducing unit 130 (interprets) identifies the codes (“0” or “1”) of the electrical signal by comparing the electrical signal output from the pre-amplifier 120 with a predetermined threshold. The reproducing unit 130 then reproduces and outputs the identified codes. The threshold is a threshold value to identify the codes of the electrical signal. For example, the reproducing unit 130 identifies a code to be “1” when the voltage of the electrical signal is higher than the threshold and identifies a code to be “0” when the voltage of the electrical signal is lower than the threshold.

The reproducing unit 130 identifies the codes of the electrical signal using a threshold adjusted according to a threshold adjustment signal output from the D/A converting unit 180. When no threshold adjustment signal is output from the D/A converting unit 180, the reproducing unit 130 identifies the electrical signal using the central value (for example, about 50%) of the amplitude of the electrical signal, as the threshold.

The low pass filter 150 extracts a sudden variation of a signal power component of the electrical signal output from the photoreceiver element 110. The signal power component of the electrical signal is the voltage of an envelope of the electrical signal and is a component that represents the power of the electrical signal. The sudden variation of the signal power component is a sudden variation of the signal power component to the degree that the calculating process of the threshold by the calculating unit 170 is unable to keep up with the variation.

More specifically, the low pass filter 150 blocks the main signal component of the electrical signal output from the photoreceiver element 110. For example, when the main signal component of an optical signal input to the optical regenerating apparatus 100 has a frequency equal to or higher than 100 kHz, the low pass filter 150 blocks frequency components having frequencies equal to or higher than 100 kHz in the electrical signal output from the photoreceiver element 110.

The low pass filter 150 passes a sudden variation of the signal power component in the electrical signal output from the photoreceiver element 110. For example, when the sudden variation of the signal power component has a frequency equal to or lower than 1 kHz, the low pass filter 150 passes the frequency components having frequencies equal to or lower than 1 kHz in the electrical signal output from the photoreceiver element 110.

Therefore, in this case, denoting the cut-off frequency of the low pass filter 150 by “fc (LPF)”, the low pass filter 150 is configured to have a cut-off frequency fc(LPF) that is 1 kHz<fc(LPF)<100 kHz. The low pass filter 150 outputs the extracted signal power component to the A/D converting unit 160 and the optical variation detecting unit 190.

The A/D converting unit 160, the calculating unit 170, and the D/A converting unit 180 constitute a threshold adjusting unit that calculates, based on the signal power component output from the low pass filter 150, a threshold that is lower than the central value of the amplitude of the electrical signal. The threshold adjusting unit, according to the calculation result, adjusts the threshold in the reproducing unit 130. The A/D converting unit 160 converts the signal power component output from the low pass filter 150 into a digital signal and outputs the digital signal to the calculating unit 170.

The calculating unit 170 calculates a threshold adjusted according to the signal power component output from the A/D converting unit 160. For example, the calculating unit 170 calculates, as the threshold, a value that is about 30% of the amplitude of the electrical signal output to the reproducing unit 130. The calculating unit 170 outputs to the D/A converting unit 180, a threshold adjustment signal indicating that the threshold is to be adjusted to the calculated threshold. When a flag signal is output from the optical variation detecting unit 190, the calculating unit 170 suspends the calculation of the threshold.

The calculating unit 170 includes, for example, a CPU. The calculating unit 170 calculates the threshold at predetermined control intervals at the timing at which the CPU configuring the calculating unit 170 processes. The D/A converting unit 180 converts the threshold adjustment signal output from the calculating unit 170 into an analog signal and outputs the analog signal to the reproducing unit 130 and thereby, adjusts the threshold in the reproducing unit 130.

The optical variation detecting unit 190 (suspending unit), with respect to the signal power component output from the low pass filter 150, detects a variation that is equal to or larger than a predetermined magnitude. When the optical variation detecting unit 190 detects a variation that is equal to or larger than the predetermined magnitude, the optical variation detecting unit 190 outputs a flag signal to the calculating unit 170 and thereby, causes the calculation of the threshold by the calculating unit 170 to be suspended. Hence, the adjustment of the threshold in the reproducing unit 130 is suspended.

FIG. 2 is a diagram of the adjustment of the threshold at the reproducing unit. In FIG. 2, a reference numeral “211” denotes the amplitude of the electrical signal input into the reproducing unit (when the amplitude is small); a reference numeral “221” denotes the amplitude of the electrical signal input into the reproducing unit (when the amplitude is large); and a reference numeral “230” denotes an threshold that is 50% of the amplitude of the electrical signal.

When the amplitude of the electrical signal input into the reproducing unit is the amplitude denoted by “211”, the calculating unit 170 calculates a threshold 212 that is about 30% of the amplitude 211. In this case, the reproducing unit 130 identifies the code of the electrical signal using the threshold 212 obtained by offsetting the threshold 230, which is 50% of the amplitude, by the amount denoted by “213”.

When the amplitude of the electrical signal input into the reproducing unit is the amplitude denoted by “221”, the calculating unit 170 calculates a threshold 222 that is about 30% of the amplitude 221. In this case, the reproducing unit 130 identifies the code of the electrical signal using the threshold 222 obtained by offsetting the threshold 230, which is 50% of the amplitude, by the amount denoted by “223”.

A configuration in which the calculating unit 170 calculates a threshold that is about 30% of the amplitude of the electrical signal has been described. However, the threshold calculated by the calculating unit 170 is properly set according to the ASE noise included in the optical signal received by the optical regenerating apparatus 100, and the number and the characteristics of the optical amplifiers in the optical communication system. For example, configuration may be such that the calculating unit 170 calculates a threshold that is about 40% of the amplitude of the electrical signal.

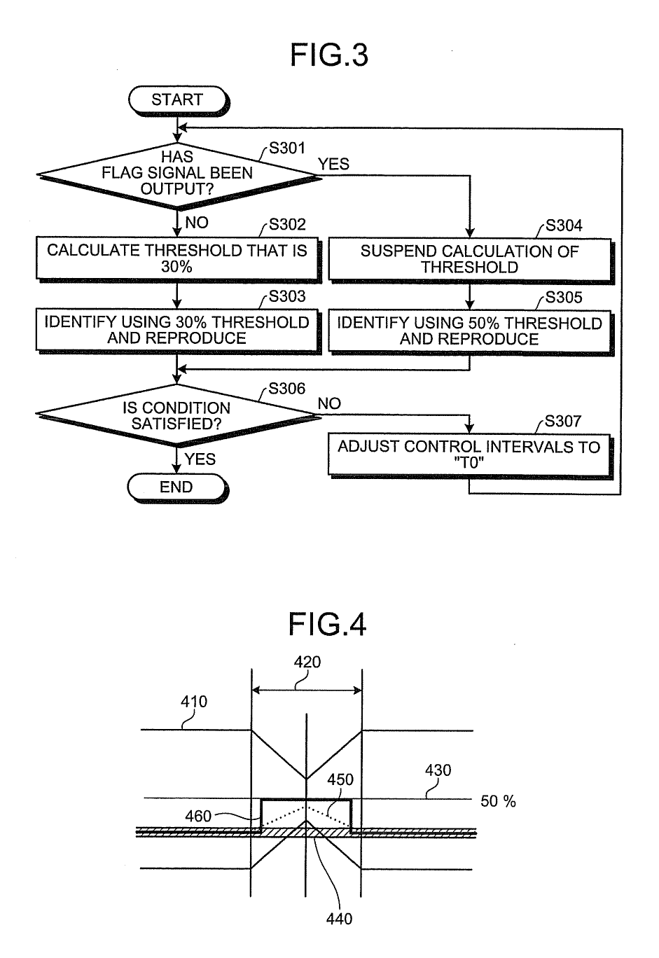

FIG. 3 is a flowchart of an example of the operation of the optical regenerating apparatus according to the first embodiment. As depicted in FIG. 2, the calculating unit 170 determines whether a flag signal has been output from the optical variation detecting unit 190 (step S301). If no flag signal has been output (step S301: NO), the calculating unit 170 calculates a threshold that is 30% of the amplitude of the electrical signal according to the power of the signal power component output from the A/D converting unit 160 (step S302).

The reproducing unit 130, using the threshold that is 30% of the amplitude of the electrical signal and calculated at step S302, identifies and reproduces the code of the electrical signal (step S303); and the procedure proceeds to step S306. If a flag signal has been output at step S301 (step S301: YES), the calculating unit 170 suspends the calculation of the threshold (step S304).

Hence, the adjustment of the threshold by the reproducing unit 130 is suspended. The reproducing unit 130, using the threshold that is 50% of the amplitude of the electrical signal, identifies the code of the electrical signal and, reproduces and outputs the code (step S305). Whether a predetermined condition for termination is satisfied is determined (step S306).

If the predetermined condition for termination is not satisfied at step S306 (step S306: NO), the calculating unit 170 adjusts each of the control intervals for the processes executed at steps S301 to S306 to T0 (for example, 100 ms) by waiting for each of the processes (step S307); and the procedure returns to step S301 and is continued. If the predetermined condition for termination is satisfied (step S306: YES), a series of processes comes to an end.

FIG. 4 is a diagram of a mechanism of the optical regenerating apparatus according to the first embodiment. In FIG. 4, a reference numeral “410” denotes the amplitude of the electrical signal output from the photoreceiver element 110, and a reference numeral “420” denotes a time period during which the power of the optical signal input into the optical regenerating apparatus 100 suddenly varies due to the addition or the reduction of other CHs in the WDM optical communication system.

A reference numeral “430” denotes a threshold that is 50% of the amplitude 410 of the electrical signal. Reference numerals “440”, “450”, and “460” denote thresholds in the reproducing unit 130. As a result of the calculation by the calculating unit 170, each of the thresholds 440, 450, and 460 is 30% of the amplitude 410 of the electrical signal during a normal state (exclusive of the time period 420).

The reference numeral “440” denotes a threshold in the reproducing unit 130 when it is assumed that the optical variation detecting unit 190 does not suspend the calculation of the threshold by the calculating unit 170 and the calculation of the threshold by the calculating unit 170 does not keep up with the variation of the power of the optical signal. In this case, the threshold 440 is a threshold that is 30% of the amplitude 410 of the electrical signal during a normal state.

The reference numeral “450” denotes a threshold in the reproducing unit 130 when it is assumed that the optical variation detecting unit 190 does not suspend the calculation of the threshold by the calculating unit 170 and the calculation of the threshold by the calculating unit 170 keeps up with the variation of the power of the optical signal. In this case, the threshold 450 follows the variation in power and continues to be a threshold that is 30% of the amplitude 410 of the electrical signal even during the time period 420.

A reference numeral “460” denotes a threshold of the present embodiment. In the present embodiment, when the optical variation detecting unit 190 detects a sudden variation in the power of the optical signal, the optical variation detecting unit 190 outputs a flag signal to the calculating unit 170 and thereby, causes the calculation of the threshold by the calculating unit 170 to be suspended. Thereby, the threshold 460 in the reproducing unit 130 becomes a threshold that is 50% of the amplitude 410 of the electrical signal during the time period 420.

When the power of the optical signal begins to return toward its original state and the variation of the amplitude 410 of the electrical signal becomes equal to or less than a predetermined magnitude, the optical variation detecting unit 190 stops outputting the flag signal to the calculating unit 170, causing the calculation of the threshold 460 by the calculating unit 170 to resume. Thereby, the threshold 460 in the reproducing unit 130 after the time period 420 is a threshold that is 30% of the amplitude 410 of the electrical signal.

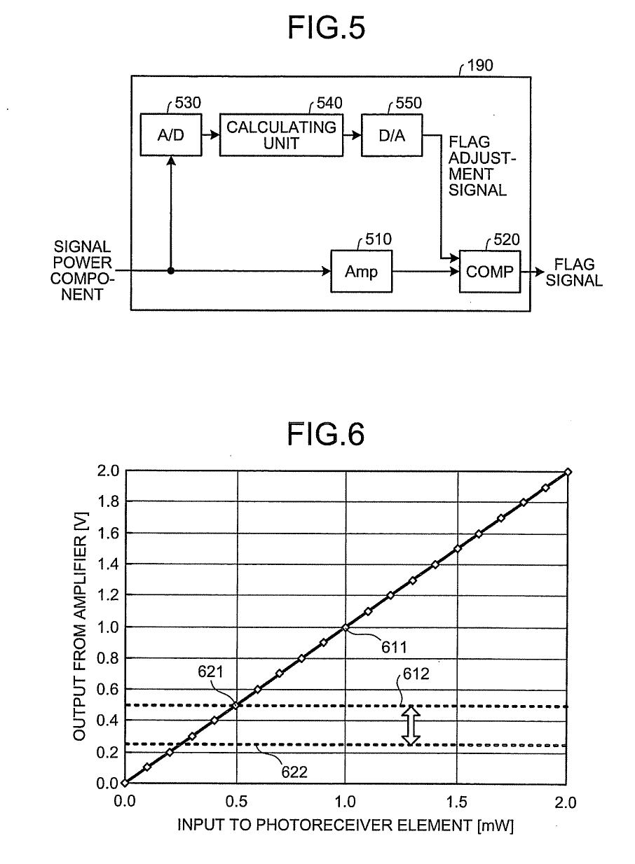

FIG. 5 is a block diagram of an exemplary configuration of the optical variation detecting unit of the optical regenerating apparatus according to the first embodiment. As depicted in FIG. 5, the exemplary configuration of the optical variation detecting unit 190 included in the optical regenerating apparatus 100 according to the first embodiment includes an amplifier 510 (Amp), a comparing unit 520 (COMP), an A/D converting unit 530, a calculating unit 540, and a D/A converting unit 550. The signal power component output from the low pass filter 150 is output to the amplifier 510 and the A/D converting unit 530.

The amplifier 510 linearly amplifies the signal power component output from the low pass filter 150 and outputs the amplified component to the comparing unit 520. The comparing unit 520, with respect to the signal power component, detects a variation that is equal to or greater than a predetermined magnitude by comparing the signal power component output from the amplifier 510 with a predetermined flag threshold value. The comparing unit 520 adjusts the flag threshold value based on a flag adjustment signal output from the D/A converting unit 550.

For example, when the voltage of the signal power component is higher than the flag threshold value, the comparing unit 520 determines that there is no variation of the signal power component equal to or larger than the predetermined magnitude and the comparing unit 520 does not output the flag signal to the calculating unit 170. On the other hand, when the signal power component is lower than the flag threshold value, the comparing unit 520 determines that there is variation of the signal power component equal to or larger than the predetermined magnitude and the comparing unit 520 outputs the flag signal to the calculating unit 170.

The A/D converting unit 530, the calculating unit 540, and the D/A converting unit 550 constitute a flag threshold value adjusting unit that adjusts the flag threshold value in the comparing unit 520 according to the signal power component. The A/D converting unit 530 converts the signal power component output from the low pass filter 150 into a digital signal and outputs the digital signal to the calculating unit 540.

The calculating unit 540 calculates the flag threshold value based on the signal power component output from the A/D converting unit 530. For example, the calculating unit 540 calculates, as the flag threshold value, power that is a half of the signal power component during a normal state. The calculating unit 540 outputs to the D/A converting unit 550 a flag adjustment signal indicating that the flag threshold value is to be the calculated flag threshold value. The calculating unit 540 is configured by, for example, a CPU.

Here, the calculating unit 170 and the calculating unit 540 may be configured by the same CPU. The calculating unit 540 calculates a flag threshold value for each of the predetermined control intervals at the timing at which the CPU configuring the calculating unit 540 processes. The D/A converting unit 550 converts the flag adjustment signal output from the calculating unit 540 into an analog signal and outputs the analog signal to the comparing unit 520 and thereby, adjusts the flag threshold value in the comparing unit 520.

FIG. 6 is a diagram of an example of the operation of the optical variation detecting unit of the optical regenerating apparatus according to the first embodiment. In FIG. 6, the abscissa represents the power [mW] of the optical signal input to the photoreceiver element 110 of the optical regenerating apparatus 100 and the ordinate represents the power [V] of the signal power component output from the amplifier 510. Because the amplifier 510 is a linear amplifier, the power of the signal power component output from the amplifier 510 is proportional to the power of the optical signal input into the optical regenerating apparatus 100.

Specific examples of a calculation by the calculating unit 540 will be described where power that is a half of the signal power component during a normal state is calculated as the flag threshold value. When the power of the signal power component during a normal state is 1.0 V as denoted by a reference numeral “611”, the calculating unit 540 calculates a value of 0.5 V as the flag threshold value as denoted by a reference numeral “612”. When the power of the electrical signal during a normal state is 0.5 V as denoted by a reference numeral “621”, the calculating unit 540 calculates a value of 0.25 V as the flag threshold value as denoted by a reference numeral “622”.

Thereby, the flag threshold value in the comparing unit 520 is adjusted according to the power of the optical signal input to the optical regenerating apparatus 100 during a normal state. Therefore, the optical variation detecting unit 190 detects any sudden variation in the power of the optical signal regardless of the power of the optical signal input into the optical regenerating apparatus 100 during a normal state.

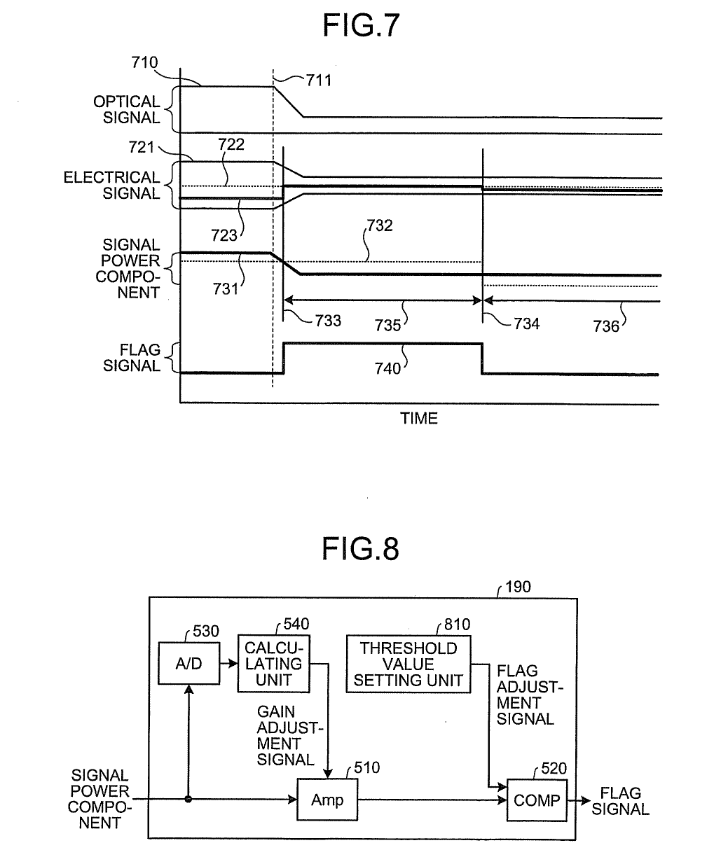

FIG. 7 is a diagram of an example of signals in the components of the optical regenerating apparatus according to the first embodiment. In FIG. 7, the abscissa represents time, a reference numeral “710” denotes an optical signal input to the optical regenerating apparatus 100, and a time point 711 represents a time point at which the power of the optical signal 710 input to the optical identification reproducing apparatus 100 starts to suddenly decrease due to the addition or the reduction of other CHs in the WDM optical communication system.

A reference numeral “721” denotes an electrical signal output from the pre-amplifier 120 and input to the reproducing unit 130. The power of the electrical signal 721 decreases in response to the decrease in the power of the optical signal 710. A reference numeral “722” denotes a threshold that is 50% of the amplitude of the electrical signal 721. A reference numeral “723” denotes a threshold in the reproducing unit 130.

A reference numeral “731” denotes a signal power component output from the low pass filter 150 and input to the optical variation detecting unit 190. The power of the signal power component 731 decreases in response to the decrease in the power of the optical signal 710. A reference numeral “732” denotes a flag threshold value in the comparing unit 520. A reference numeral “733” denotes a time point at which the signal power component 731 starts to be lower than the flag threshold value 732.

The calculating unit 540 calculates the flag threshold value 732 at predetermined control intervals at the timing at which the CPU configuring the calculating unit 540 processes. A reference numeral “734” denotes a time point at which the calculating unit 540 calculates the flag threshold value 732. At the time point 734, the calculating unit 540 calculates the flag threshold value 732 according to the signal power component 731 that has decreased in power.

Therefore, after the signal power component 731 decreases, the flag threshold value 732 is maintained until the time point 734 at which a time period 735 has elapsed. The time period 735 is established according to the control interval for the calculating unit 540 to calculate the flag threshold value 732, and a time period spanning from the time when the calculating unit 540 calculates the flag threshold value 732 to the time when the power of the signal power component 731 decreases.

During the time period 735, the flag threshold value 732 is maintained from the time when the power of the signal power component 731 decreases. Hence, because the time period 735 is established, variation of the flag threshold value 732 is delayed with respect to the decrease in the power of the signal power component 731. Thereby, a situation where the signal power component 731 does not become lower than the flag threshold value 732 does not occur because the flag threshold value 732 is prevented from simultaneously decreasing with a decrease in the power of the signal power component 731. Thus, the optical variation detecting unit 190 is able to detect variation of the signal power component 731.

A reference numeral “740” denotes a flag signal output from the comparing unit 520 to the calculating unit 540. Until the time point 733, the comparing unit 520 does not output the flag signal 740 to the calculating unit 540 because the signal power component 731 is higher than the flag threshold value 732. At this time, the threshold 723 is adjusted to a value that is 30% of the amplitude of the electrical signal 721.

During the time period 735, the comparing unit 520 outputs the flag signal 740 to the calculating unit 540 because the signal power component 731 is lower than the flag threshold value 732. During this time, the calculation of the threshold 723 by the calculating unit 170 is suspended. Therefore, the reproducing unit 130 uses the threshold 722 having a value that is 50% of the amplitude of the electrical signal 721.

During the time period 736, the comparing unit 520 does not output the flag signal 740 to the calculating unit 540 because the signal power component 731 is greater than the flag threshold value 732. During this time, the calculation of the threshold 723 by the calculating unit 170 is resumed. Therefore, the threshold 723 is a value adjusted to 30% of the amplitude of the electrical signal 721.

As described, according to the optical regenerating apparatus 100 of the first embodiment, when a sudden variation of the power of the optical signal is detected, the calculation of the threshold is suspended and thereby, the threshold may be fixed at the central value of the amplitude of the electrical signal (see the reference numeral “1920” of FIG. 19). Thus, a situation is prevented where identification of the code of the optical signal is impossible because the calculation of the threshold does not keep up with the variation and tolerance against a sudden variation in the power of an optical signal is improved.

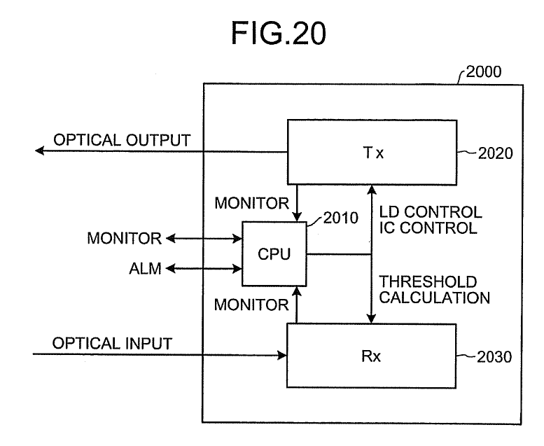

Because tolerance against a sudden variation in the power of an optical signal is improved regardless of the processing speed of the CPU, processing executed by the CPU for other components in the optical communicating apparatus (see the reference numeral “2000” of FIG. 20) is not affected. No CPU needs to be additionally equipped to improve the processing speed of the calculation of the threshold and therefore, problems such as increased cost and increased size of the apparatus may be prevented.

According to the optical regenerating apparatus 100 of the first embodiment, a flag threshold value based on the signal power component output from the A/D converting unit 530 is calculated and thereby, any sudden variations in the power of the optical signal may be detected regardless of the power of the optical signal input into the optical regenerating apparatus 100 during a normal state. The optical regenerating apparatus 100 according to the first embodiment may be realized by a simple configuration obtained by only adding the optical variation detecting unit 190 to the configuration of the conventional optical regenerating apparatus (see the reference numeral “1700” of FIG. 17).

FIG. 8 is a block diagram of a first exemplary configuration of an optical variation detecting unit of an optical regenerating apparatus according to a second embodiment. In FIG. 8, components identical to the components depicted in FIG. 5 are given the same reference numerals used in FIG. 5 and the description therefor is omitted. As depicted in FIG. 8, the first exemplary configuration of the optical variation detecting unit 190 includes the amplifier 510, the comparing unit 520, the A/D converting unit 530, the calculating unit 540, and a threshold setting unit 810.

The amplifier 510 adjusts gain for the signal power component, based on a gain adjustment signal output from the calculating unit 540. The calculating unit 540 (power adjusting unit), based on the signal power component output from the A/D converting unit 530, calculates gain by which the power of the signal power component output from the amplifier 510 becomes constant. For example, the calculating unit 540 calculates gain that is in inversely proportional to the signal power component output from the A/D converting unit 530.

The calculating unit 540 calculates the gain at predetermined control intervals at the timing at which the CPU configuring the calculating unit 540 processes. The calculation unit 540 outputs to the amplifier 510, a gain adjustment signal indicating that the gain is to be adjusted to the calculated gain. Thereby, the power of the signal power component output from the amplifier 510 is adjusted to be constant.

The threshold value setting unit 810 outputs a constant flag adjustment signal to the comparing unit 520. The comparing unit 520 maintains the flag threshold value to be constant based on the constant flag adjustment signal output from the threshold value setting unit 810. Configuration may be such that the comparing unit 520 maintains a predetermined constant flag threshold value without providing the threshold setting value unit 810.

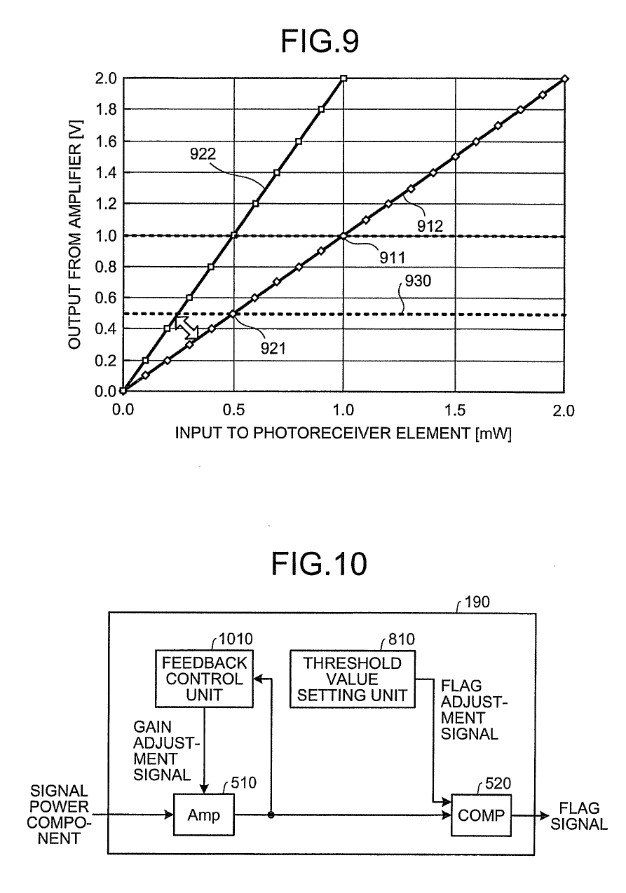

FIG. 9 is a diagram of an example of the operation of the optical variation detecting unit included in the optical regenerating apparatus according to the second embodiment. In FIG. 9, description for portions identical to the portions depicted in FIG. 6 is omitted. With respect to the first exemplary configuration of the optical variation detecting unit 190, a specific example in which the calculating unit 540 adjusts the power of the signal power component output from the amplifier 540 to be constant will be described.

When the power of the signal power component during a normal state is 1.0 V as denoted by a reference numeral “911”, the calculating unit 540 outputs to the amplifier 510, a gain adjustment signal indicating that the power of the signal power component output from the amplifier 510 is to be maintained. In this case, the amplifier 510 maintains the gain as denoted by a reference numeral “912”.

When the power of the signal power component during a normal state is 0.5 V as denoted by a reference numeral “921”, the calculating unit 540 outputs to the amplifier 510, a gain adjustment signal that causes the power of the signal power component output from the amplifier 510 to be increased to 1.0 V. In this case, the amplifier 510 increases the gain as denoted by a reference numeral “922” and thereby, the power of the signal power component output from the amplifier 510 becomes 1.0 V.

Thus, the power of the signal power component output from the amplifier 510 is always 1.0 V. The comparing unit 520 maintains the flag threshold value at 0.5 V as denoted by a reference numeral “930”. Therefore, the optical variation detecting unit 190, with respect to the power of the optical signal, is able to detect variations of a magnitude equal to or greater than a predetermined magnitude, regardless of the power of the optical signal input to the optical regenerating apparatus 100 during a normal state.

FIG. 10 is a block diagram of a second exemplary configuration of the optical variation detecting unit of the optical regenerating apparatus according to the second embodiment. In FIG. 10, components identical to the components depicted in FIG. 8 are given the same reference numerals used in FIG. 8 and the description therefor is omitted. As depicted in FIG. 10, the second exemplary configuration of the optical variation detecting unit 190 includes the amplifier 510, the comparing unit 520, a feedback control unit 1010, and the threshold setting unit 810.

The signal power component output from the low pass filter 150 is output to the amplifier 510. The amplifier 510 adjusts the gain for the signal power component, based on the gain adjustment signal output from the feedback control unit 1010. The feedback control unit 1010 (power adjusting unit) monitors the power of the signal power component output from the amplifier 510 to the comparing unit 520 and calculates gain by which the power of the signal power component output from the amplifier 510 becomes constant.

For example, the feedback control unit 1010 calculates gain that is in inversely proportional to the power of the signal power component output from the amplifier 510 to the comparing unit 520. The feedback control unit 1010 is configured by, for example, a CPU. Here, the above calculating unit 170 and the feedback control unit 1010 may be configured by the same CPU.

The feedback control unit 1010 calculates gain for each of the predetermined control intervals at the timing at which the CPU configuring the feedback control unit 1010 processes. The feedback control unit 1010 outputs to the amplifier 510, a gain adjustment signal indicating that the gain is to be adjusted to the calculated gain. Thereby, the power of the signal power component output from the amplifier 510 becomes constant.

As to the operation of the second exemplary configuration of the optical variation detecting unit 190, the operation is identical to the operation of the first exemplary configuration of the optical variation detecting unit 190 (see FIG. 9) and therefore, an illustration thereof is omitted. For example, the feedback control unit 1010 outputs to the amplifier 510, a gain adjustment signal that causes the power of the signal power component output from the amplifier 510 to be maintained at 1.0 V.

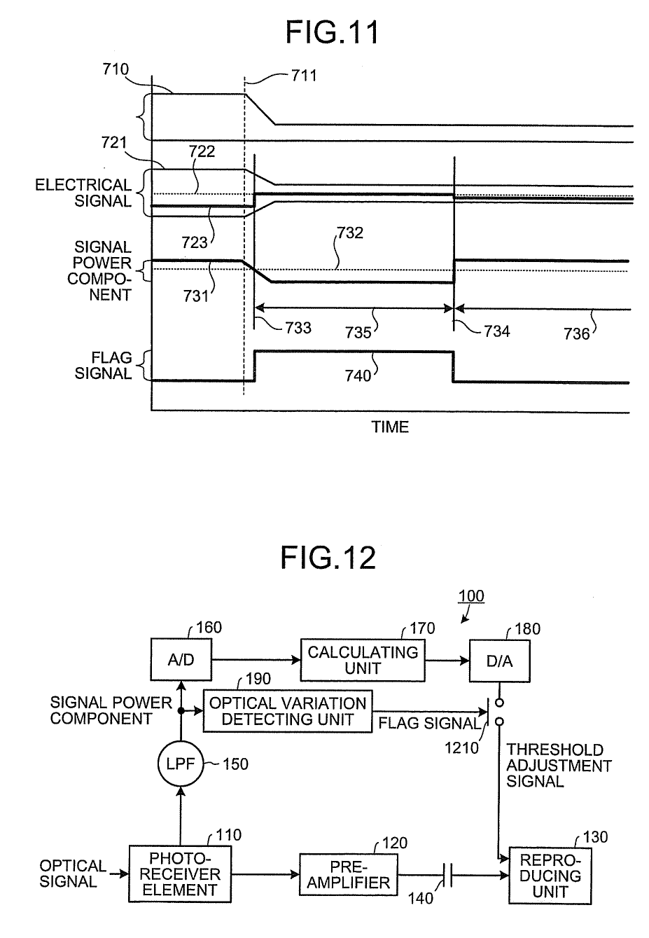

FIG. 11 is a diagram of an example of signals in the components of the optical regenerating apparatus according to the second embodiment. In FIG. 11, description for portions identical to the portions depicted in FIG. 7 is omitted. During the time period 735, the power of the signal power component 731 decreases in response to a decrease in the power of the optical signal 710. At the time point 734, the calculating unit 540 or the feedback control unit 1010 increases the decreased power of the signal power component 731 to the previous power.

Meanwhile, the flag threshold value 732 in the comparing unit 520 is maintained to be constant. Therefore, during a time period 736, the comparing unit 520 does not output the flag signal 740 to the calculating unit 540 because the signal power component 731 is higher than the flag threshold value 732. In this case, the threshold 723 is adjusted to a value that is 30% of the amplitude of the electrical signal 721.

In this manner, according to the optical regenerating apparatus 100 according to the second embodiment, the power of the signal power component output from the amplifier 510 is maintained to be constant and the flag threshold value in the comparing unit 520 is maintained to be constant and thereby, any sudden variation in the power of the optical signal is detected regardless of the power of an optical signal input to the optical regenerating apparatus 100 during a normal state. Therefore, according to the optical regenerating apparatus 100 of the second embodiment, an effect is achieved identical to that of the optical regenerating apparatus 100 according to the first embodiment.

FIG. 12 is a block diagram of an example of a configuration of an optical regenerating apparatus according to a third embodiment. In FIG. 12, components identical to the components depicted in FIG. 1 are given the same reference numerals used in FIG. 1 and the description therefor is omitted. As depicted in FIG. 12, the optical regenerating apparatus 100 according to the third embodiment includes a switch 1210 in addition to the configuration of the optical regenerating apparatus 100 according to the first embodiment.

When the optical variation detecting unit 190 detects a sudden variation of the signal power component, the optical variation detecting unit 190 outputs a flag signal to the switch 1210. The switch 1210 is provided between the D/A converting unit 180 and the reproducing unit 130. When no flag signal is output from the optical variation detecting unit 190, the switch 1210 passes the threshold adjustment signal output from the D/A converting unit 180, to the reproducing unit 130.

When a flag signal is output from the optical variation detecting unit 190, the switch 1210 blocks the threshold adjustment signal output from the D/A converting unit 180 to the reproducing unit 130. Thereby, the threshold adjustment signal is not input into the reproducing unit 130 and the adjustment of the threshold in the reproducing unit 130 is suspended.

In this manner, according to the optical regenerating apparatus 100 of the third embodiment, when a sudden variation in the power of the optical signal is detected, the threshold adjustment signal output from the D/A converting unit 180 to the reproducing unit 130 is blocked and thereby, the adjustment of the threshold in the reproducing unit 130 is suspended. Therefore, according to the optical regenerating apparatus 100 of the third embodiment, an effect is achieved identical to that of the optical regenerating apparatus 100 according to the first embodiment.

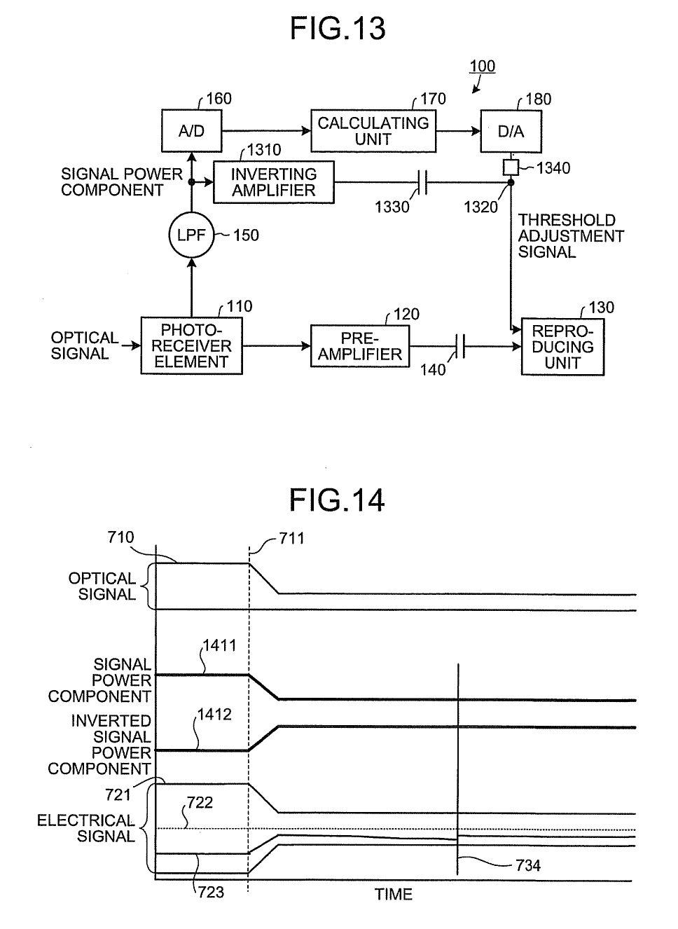

FIG. 13 is a block diagram of an example of a configuration of an optical regenerating apparatus according to a fourth embodiment. In FIG. 13, components identical to the components depicted in FIG. 1 are given the same reference numerals used in FIG. 1 and the description therefor is omitted. As depicted in FIG. 13, the optical regenerating apparatus 100 according to the fourth embodiment includes an inverting amplifier 1310, an adding unit 1320, a capacitor 1330, and a resistor 1340 instead of the optical variation detecting unit 190 of the optical regenerating apparatus 100 according to the first embodiment.

The low pass filter 150 outputs the extracted signal power component to the A/D converting unit 160 and the inverting amplifier 1310. The inverting amplifier 1310 inverts the power of the signal power component output from the low pass filter 150. The inverting amplifier 1310 outputs to the adding unit 1320, the inverted signal power component whose power is inverted.

The D/A converting unit 180 outputs to the adding unit 1320, a threshold adjustment signal output from the calculating unit 170. The adding unit 1320 adds the threshold adjustment signal output from the D/A converting unit 180, to the inverted signal power component output from the inverting amplifier 1310, and outputs the resulting signal to the reproducing unit 130.

The capacitor 1330 is provided between the inverting amplifier 1310 and the adding unit 1320. The inverted signal power component output from the inverting amplifier 1310 to the adding unit 1320 is capacitive-coupled by the capacitor 1330. The resistor 1340 is provided between the D/A converting unit 180 and the adding unit 1320. The threshold adjustment signal output from the D/A converting unit 180 to the adding unit 1320 passes through the resistor 1340.

FIG. 14 is a diagram of an example of signals in the components of the optical regenerating apparatus according to the fourth embodiment. In FIG. 14, description for portions identical to the portions depicted in FIG. 7 is omitted. A reference numeral 1411 denotes the signal power component output from the low pass filter 150 to the inverting amplifier 1310 (and is same as the signal power component 731, see FIG. 7).

A reference numeral 1412 denotes the inverted signal power component output from the inverting amplifier 1310 to the adding unit 1320. The power of the inverted signal power component 1412 is the inverse of the power of the signal power component 1411. Until the time point 711, the threshold 723 is adjusted to a value that is 30% of the amplitude of the electrical signal 721.

At and after the time point 711, the inverted signal power component 1412 output from the inverting amplifier 1310 to the adding unit 1320 increases in response to a decrease in the power of the optical signal 710. In this case, the threshold adjustment signal to which the inverted signal power component 1412 has been added by the adding unit 1320 increases in response to the increase of the inverted signal power component 1412.

In other words, the threshold 723 in the reproducing unit 130 increases in response to the decrease in the power of the optical signal 710. Therefore, the threshold 723 in the reproducing unit 130 keeps up with the variation of the power of the optical signal 710. The adjustment of the threshold 723 in the reproducing unit 130 is an analog process and may be executed at a high speed regardless of the processing speed of the CPU.

In this manner, according to the optical regenerating apparatus 100 of the fourth embodiment, the threshold adjustment signal and the inverted signal power component are added to each other and the resulting signal is output to the reproducing unit 130 and thereby, the threshold 723 in the reproducing unit 130 may be caused to keep up with the variation of the power of the optical signal 710 at a high speed. Therefore, tolerance against a sudden variation in the power of an optical signal is improved.

According to the optical regenerating apparatus 100 of the fourth embodiment, tolerance against a sudden variation in the power of an optical signal may be improved regardless of the processing speed of the CPU and therefore, processing executed by the CPU for other components in the optical communicating apparatus (see the reference numeral “2000” of FIG. 20) is not affected. No CPU needs to be additionally equipped to improve the processing speed of the calculation of the threshold and therefore, problems such as increased cost and increased size of the apparatus may be prevented.

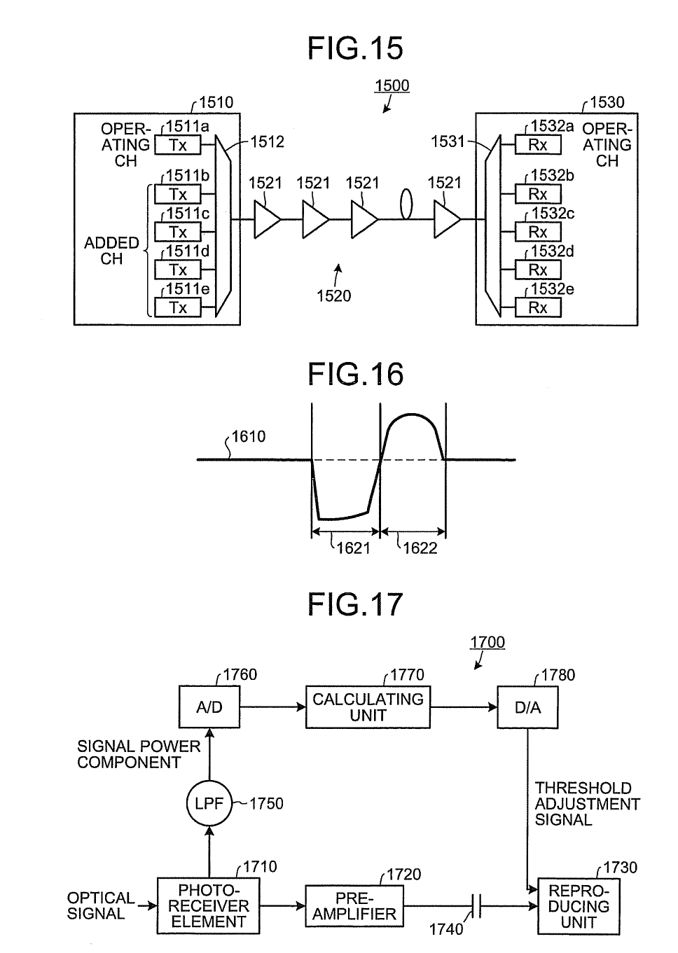

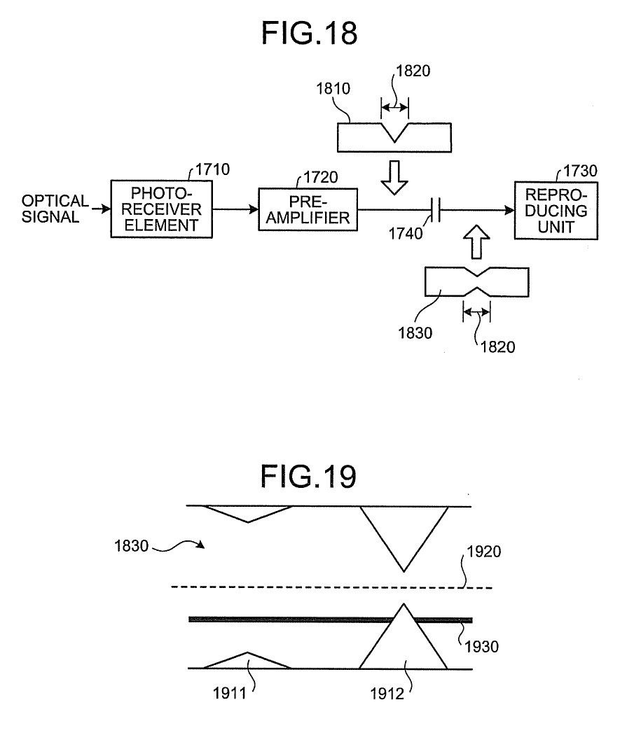

Not particularly depicted in the drawings, the optical regenerating apparatus 100 according to the above embodiments is suitable for application to an optical receiving apparatus (see the reference numeral “1530” of FIG. 15) in a WDM optical communication system that uses optical amplifiers. In this case, the optical receiving apparatus receives an optical signal amplified by the optical amplifiers; and the optical regenerating apparatus 100 identifies the code of the optical signal received by the optical receiving apparatus, and reproduces and outputs the code. Thereby, tolerance against a sudden variation in the power of an optical signal due to the addition or the reduction of other CHs in the WDM optical communication system may be improved.

As described, according to aspects of the present embodiments, when a sudden variation in the power of an optical signal is detected, the calculation of a threshold is suspended and thereby, the threshold may be fixed at the central value of the amplitude of the electrical signal. Hence, a situation may be prevented where identification of the code of the optical signal becomes impossible. Therefore, tolerance against any sudden variations in the power of the optical signal may be improved.

Consequently, no backup line as a counter measure against interruption of a signal needs to be buried and therefore, the cost of the optical communication system may be reduced. Tolerance against a sudden variation in the power of an optical signal caused by the addition or the reduction of other CHs or by any of the optical amplifiers in the WDM optical communication system is improved and thus, the addition and the reduction of CHs and the optical amplifiers is facilitated.

According to aspects of the present embodiments, tolerance against a sudden variation in the power of an optical signal may be improved regardless of the processing speed of the CPU and therefore, processing executed by the CPU for other components in the optical communicating apparatus is not affected. No CPU needs to be additionally equipped to improve the processing speed of the calculation of the threshold and therefore, problems such as increased cost and increased size of the apparatus may be prevented.

According to aspects of the present embodiments, the threshold adjustment signal and the inverted signal power component are added to each other and thereby, the threshold may be caused to keep up with the variation of the power of an optical signal at a high speed. Therefore, tolerance against a sudden variation in the power of an optical signal may be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical regenerating apparatus comprising:
a photoreceiver unit that receives an optical signal and converts the optical signal into an electrical signal;
a reproducing unit that identifies a code of the electrical signal by comparing the electrical signal with a threshold, and reproduces and outputs the identified code;
a threshold adjusting unit that calculates a threshold that is lower than the central value of the amplitude of the electrical signal and according to the calculated threshold, adjusts the threshold used by the reproducing unit; and
a control unit that, based on a variation in the power of the electrical signal, controls the adjustment of the threshold by the threshold adjusting unit.

2. The optical regenerating apparatus according to claim 1, wherein
the control unit is a suspending unit that, with respect to the power of the electrical signal, detects a variation equal to or greater than a predetermined magnitude and that upon detecting the variation, suspends the calculation of the threshold by the threshold adjusting unit.

3. The optical regenerating apparatus according to claim 2, wherein
the reproducing unit identifies the code using the central value of the amplitude of the electrical signal as the threshold, when the adjustment of the threshold by the threshold adjusting unit is suspended.

4. The optical regenerating apparatus according to claim 2, wherein
the control unit comprises:
a comparing unit that, with respect to the power of the electrical signal, detects a variation that is equal to or greater than the predetermined magnitude by comparing the power of the electrical signal with a flag threshold value; and
a flag threshold value adjusting unit that calculates the flag threshold value according to the power of the electrical signal and according to the calculated flag threshold value, adjusts the flag threshold value at the comparing unit.

5. The optical regenerating apparatus according to claim 2, wherein
the control unit comprises:
a comparing unit that, with respect to the power of the electrical signal, detects a variation that is equal to or greater than the predetermined magnitude by comparing the power of the electrical signal with a fixed flag threshold value; and
a power adjusting unit that adjusts the power of the electrical signal compared with the fixed flag threshold value so that the power is constant.

6. The optical regenerating apparatus according to claim 2, wherein
the threshold adjusting unit adjusts the threshold by outputting a threshold adjustment signal to the reproducing unit, and
the control unit blocks the threshold adjustment signal output to the reproducing unit upon detecting a variation that is equal to or greater than the predetermined magnitude.

7. The optical regenerating apparatus according to claim 1, wherein
the threshold adjusting unit adjusts the threshold by outputting a threshold adjustment signal to the reproducing unit, and
the control unit inverts a power component of the electrical signal and adds the inverted power component to the threshold adjustment signal output to the reproducing unit.

8. An optical regenerating method comprising:
receiving an optical signal and converting the optical signal into an electrical signal;
identifying a code of the electrical signal by comparing the electrical signal with a threshold;
reproducing and outputting the identified code;
calculating a threshold that is lower than the central value of the amplitude of the electrical signal and according to the calculated threshold, adjusting the threshold at the identifying; and
suspending calculation of the threshold at the calculating when, with respect to the power of the electrical signal, a variation equal to or greater than a predetermined magnitude is detected.

9. An optical regenerating method comprising:
receiving an optical signal and converting the optical signal into an electrical signal;
identifying a code of the electrical signal by comparing the electrical signal with a threshold;
reproducing and outputting the identified code;
calculating a threshold that is lower than the central value of the amplitude of the electrical signal and according to the calculated threshold, adjusting the threshold at the identifying; and
inverting a power component of the electrical signal and adding the inverted power component to a threshold adjustment signal used at the identifying.
